(19) United States
(12) Patent Application Publication
(10) Pub. No.: US 2016/0210881 A9
(43) Pub. Date: Jul. 21, 2016

(54) Scientific Instrument Trainer

(71) Applicant: Tyrone Ralph Smith, Highland, CA (US)

(72) Inventor: Tyrone Ralph Smith, Highland, CA (US)

(21) Appl. No.: 14/042,568

(22) Filed: Sep. 30, 2013

Related U.S. Application Data
(60) Provisional application No. 61/721,164, filed on Nov. 1, 2012.

(51) Int. Cl. G09B 23/00

(52) U.S. Cl. CPC G09B 23/00

(57) ABSTRACT

A training system in which some parts of an instrument are virtualized while other parts are physical. Typically, those parts that are physical are those whose use requires a minimum level of user technique to obtain optimum results. An example of a physical component is a sample injection syringe. Those parts of an instrument that are virtualized are those whose operations are independent of user technique or for which user technique is largely the same in virtualized or physical forms. Examples of virtualized components may include a start button, a detector or a heater.

### CROSS-REFERENCE TO RELATED APPLICATION

Not Applicable

### TECHNICAL FIELD OF THE INVENTION

The present invention, the Scientific Instrument Trainer, relates to inventions applicable to the education and training in the use of highly sophisticated scientific instrumentation.

### STATEMENT OF FEDERALLY FUNDED RESEARCH

None.

### REFERENCE TO SEQUENCE LISTING, A TABLE OR A COMPUTER PROGRAM LISTING

Not Applicable

### BACKGROUND OF THE INVENTION

A gas chromatograph is expensive. It can cost as much as fifty thousand dollars. Upkeep, repairs and supplies add to the cost. This cost impacts the number of instruments available in the typical university laboratory. This cost also has direct influence on how much student interaction the laboratory instructor is willing to allow with such costly and delicate instrumentation.

The scientific instrument trainer mimics the laboratory instrument at a significantly reduced cost. The scientific instrument trainer allows full student interaction and provides realistic feedback. This gives the student a complete hands-on experience.

The student can learn everything from the proper sample handling techniques and instrument troubleshooting to the process of method development; Items that cannot be learned from a computer simulator, a textbook or a classroom lecture; Items that can only be learned from hands-on experimentation.

The core concept of the Scientific Instrument Trainer is to duplicate the student's interaction with the instrument and virtualize everything else. So, in the case of the gas chromatograph we duplicate the process of sample injection. This interaction with the syringe and an injection port can also be extended to HPLC and any of the hyphenated techniques like, GC-MS, GC-MS-MS and LC-MS. Once the injection sequence is duplicated, the virtualization of the instrumentation is a reasonably simple matter. The virtualization can be done in software and replicated on the monitor's screen.

### BRIEF SUMMARY OF THE INVENTION

A major factor that deters training in scientific instrumentation is the cost of the scientific instrumentation. This cost limits the number of instruments that are purchased; consequently, it limits the number of students that can gain “hands-on” experience. Other factors that come into play are concern for the integrity of the expensive instruments; not wanting the inexperienced students to break or irreparably damage the instruments. There is also instrument maintenance to consider. Also, there is the cost of supplies such as sample containers, sample components, gases and solvents. And for the instructor, there is the time and cost of preparing appropriate samples for learning purposes.

Computer simulators provide a prediction of analytical results and “images” of an instrument but they do not give the student experience in performing an analysis on an actual instrument, in particular for those aspects of an instrument where a user's technique is important. For example, a computer simulation does not provide a student with experience in proper sample injection techniques in chromatography.

Various embodiments of the invention include a “scientific instrument trainer.” The scientific instrument trainer provides a better level of training relative to purely computer simulated instruments, at a cost that is less than that of full instruments. This scientific instrument trainer serves as a trainer by mimicking the functions of an authentic scientific instrument using both real (physical) and virtual components. For example, in some embodiments the scientific instrument trainer includes a physical sample injection device and a computer system configured to simulate other components of the instrument. The physical sample injection device optionally is configured to detect aspects of a user's injection technique and communicate these aspects to the computer system such that the simulation can take into account how an injection was performed.

This scientific instrument trainer can be used in teaching analytical method development. This scientific instrument trainer can be used to teach the process of determining an “unknown”. This scientific instrument trainer can be used to teach qualitative and quantitative analysis where instrument calibration and “standard curves” are developed. This scientific instrument trainer can also be used to train students in troubleshooting typical problems associated with the operation of sophisticated analytical scientific instrumentation. This can be done without jeopardizing costly laboratory scientific instrumentation.

Optionally, a single scientific instrument trainer can simulate the operation of one or more of a variety of scientific instruments such as a Gas Liquid Chromatograph, Liquid Chromatograph, Mass Spectrometer, Atomic Absorption, Nuclear Magnetic Resonance Spectrometer, Inductively Coupled Plasma Spectrometer, atomic microcopy, optical spectrometry, x-ray spectrometry, electrochemistry, and any hyphenated versions, e.g., MS/MS, GC/MS, Ion Migration Spectrometry, MALDI/TOF, HPLC/MS and ICP-MS to name a few.

A single scientific instrument trainer may also be configured to be compatible with or simulate one or more standard data systems. For example, in one mode a scientific instrument trainer can operate using ChemStation® from Agilent and in another mode use Varian, Inc.'s Galaxie™. As such, one scientific instrument trainer can be used to simulate instruments from different manufacturers. The data system is optionally installed on the scientific instrument trainer just as it would be on an actual instrument. As such, the scientific instrument trainer can include one or more APIs configured to be compatible with standard/commercial data systems.

Optionally, a single scientific instrument trainer can simulate a variety of instruments that have the same method of sample introduction. For example, scientific instruments that require a syringe for sample introduction can be treated in a similar fashion e.g., using a physical injection port and simulation of other parts of the instrument. Instruments that require other means of sample introduction, like the NMR sample tube, because of the way the analyst interacts with the instrument to introduce the sample, are addressed accordingly. This is more an issue of the physical shape of the sample introduction device and not the technology used to transfer information from the sample introduction device to the sample analysis device. Further, a single computing device can receive sample introduction data from a variety of physical sample input devices. These devices can be of the same or different types. In some embodiments, a single computing system can simulate the operation of a plurality of instruments in parallel.

In the case of remotely located educational facilities, the students must travel to the instrument equipped laboratory. Because the Scientific Instrument Trainer requires no solvents or gases and because of its very nature, the Scientific Instrument Trainer is significantly lighter and more portable than a real world scientific instrument such as a gas chromatograph-mass spectrometer. In general, the Scientific Instrument Trainer is similar in size and weight to a common desktop computer and has similar operational requirements, i.e., electrical power. The scientific instrument trainer can be ported or shipped to and operated in any location that is convenient and appropriate for student learning.

### BRIEF DESCRIPTION OF THE SEVERAL VIEWS OF THE DRAWING

FIG. 1—Basic Functional Diagram. This figure shows the overall system components. In general, the components are a sample introduction device (115, 120), an instrument simulator and computing resources (105, 110, 125, 130, 135 and 140).

FIG. 2—Identification of Devices. This figure shows a specific instance of the Scientific Instrument Trainer. The three components are the sample input device (120, 125), the simulated instrument proxy (115) and the computing resources (110, 105, 110, 130 and 135) that will coordinate the sample introduction and provide the resultant gas chromatogram.

FIG. 3—Load syringe with sample composition. The computer (100, 105, 110, 130, and 135) communicates with the sample input device (120, 125) to identify the sample composition to be injected into the chromatograph and analyzed.

FIG. 4—Load sample composition onto chromatograph. This figure shows the actuation of sample analysis. Once the simulated instrument senses sample injection, the chromatographic simulation is initiated. The syringe (120, 125) and the injection port (115) communicate in such a manner as to identify the sample to be analyzed. This information is relayed to the computer (100, 105, 110, 130, and 135) which, in turn, presents the user with the analytical results in the same manner as provided by a real world instrument (FIG. 5).

FIG. 5—Gas Chromatograph produces chromatogram. After sample injection, the computing resource mimics a chromatograph by displaying the progression of a chromatogram and the resultant chromatographic peaks which represent the chemical components of the sample.

FIG. 6—One computer can receive data from multiple sample introduction devices. This figure is used to demonstrate that computing resources can be easily shared among a series of simulated instruments. Consequently, it is relatively easy to populate a laboratory class with these Scientific Instrument Trainers. Multiple types and embodiments of the Scientific Instrument Trainer can be simulated in a single laboratory with a single computer.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the area relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

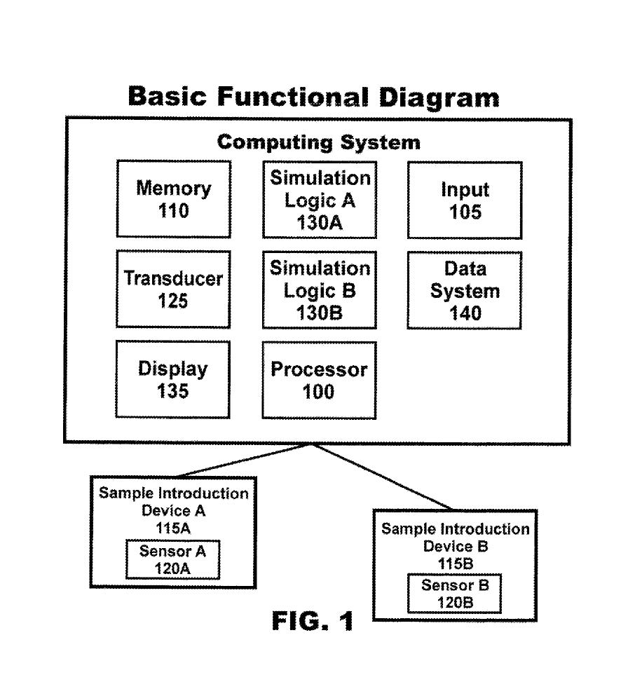

FIG. 1. An Input 105 includes logic that allows a user, e.g., a professor to input characteristics of one or more virtual samples. For example, a professor may designate the characteristics of 100 different samples. These characteristics can include chemical components, size (volume or weight), and/or virtualized physical properties of each sample. The samples may include standards and “unknowns.” Input 105 may further include logic configured to assign samples to specific students. Input 105 can include computer input devices such as a touch screen, keyboard or pointing device. Input 105 further includes the logic configured to store this information in Memory 110. One purpose of Input 105 is to receive the analyte identity and analyte amount which makes up the sample composition into the computing system.

A Sample Introduction Device 115 (individually designated 115A, 115B, etc.) is a physical device configured for a user (e.g., student) to introduce a sample. Sample Introduction Device 115 can be configured to mimic almost any sample introduction device used in connection with analytical instruments. Examples of Sample Introduction Device 115 include a syringe, a syringe+injection port, a probe, a vial holder, a sample plate, an electrochemical cell, a beaker, a vacuum interlock, a valve, an auto-sampler, and/or the like. Sample Introduction Device 115 includes at least one Sensor 120 (individually designated 120A, 120B, etc.). Sensor 120 is configured to detect a technique of a user. The detected technique can have more than one aspect of a user's technique and can include, for example, injection technique, probe introduction technique, sample plate introduction technique, vial placement technique, and/or the like. One of Sample Introduction Devices 115 optionally includes a plurality of Sensor 120. In one example, the aspects of the detected technique(s) include sample volume, speed at which a sample is introduced, variation in sample introduction rate, and/or the like.

In some embodiments Sample Introduction Device 115A includes a syringe. The syringe includes Sensor 120A configured to detect a position of a plunger of the syringe. The technique of the user is detected by monitoring movement of the plunger. In some embodiments Sample Introduction Device 115A includes both a syringe and an injection port. The injection port includes a pressure or mass sensor configured to detect the introduction of physical sample from the syringe into the injection port. The technique of the user can include, for example, how smoothly and/or quickly the sample is introduced into the injection port. The introduced sample may be a surrogate sample such as deionized water or ethanol as the system will assume that the sample includes components as designated using Input 105.

Sample Introduction Device 115A and optionally 115B are configured to communicate the output of the one or more Sensor 120 to a Transducer 125. This communication can be wired or wireless. For example an injection port can be connected to Transducer 125 using a USB (Universal Serial Bus), Wi-Fi, Bluetooth®, RFID, NFC (Near Field Communication) and/or the like. The information communicated optionally includes the identity of a syringe. For example, a professor may have used Input 105 to designate virtual contents of a set of syringes and the syringe identity communicated to Transducer 125 from Sample Introduction Device 115 includes an identifier of a syringe used to inject a dummy sample (e.g. deionized water or ethanol) into a sample port. The syringe identifier is used to look up the designated virtual contents of the syringe. As such, a user can inject water into an injection port and the Scientific Instrument Trainer will simulate the response of an instrument based on the detected user technique and the designate sample virtual contents.

Transducer 125 is configured to receive the output of Sensor 120A and/or 120B and to generate a digital value based on the received output. Transducer 125 is optionally located on Sample Introduction Device 115. Transducer 125 optionally includes an analog-to-digital converter.

In some embodiments, a simpler Sample Introduction Device can have each syringe communicate a unique identifier to the computer. The computer then associates that unique identifier to the sample composition. In this embodiment, the Sample Introduction Device needs only contain a unique identifier and not the entirety of the sample composition.

One or more Simulation Logic 130 (individually designated 130A, 130B, etc.) is configured to receive the sample identity (e.g., input device or sample number) identity, and the detected aspect(s) of user technique from Transducer 125. The sample identity is used to retrieve the sample characteristics designated using Input 105 and stored in Memory 110. Simulation Logic 130 is then configured to simulate the virtual parts of a scientific instrument based on a variety of instrument parameters, the detected aspect(s) of user technique, and the virtual contents of the sample. The instrument parameters are optionally entered by a professor and/or student using Input 105 and may or may not be tied to a specific sample. For example, a professor may designate starting instrument parameters and the student(s) may need to optimize or troubleshoot these parameters to obtain desirable analytical results.

Simulation Logic 130A is optionally configured to simulate an instrument from a first manufacturer while Simulation Logic 130B is configured to simulate an instrument from a second manufacturer.

The instrument parameters can include, but are not limited to, flow rates, temperatures, valve positions, pressures, vacuum seals, valve positions, detector properties/type, electrical connections, chromatography columns, contamination, pump properties, alignment, voltages, carrier gases, mobile phases, and/or the like. For example, in some embodiments the professor sets some instrument conditions (that optionally represent instrument problems to be solved by a student). A student can modify these and/or other instrument conditions, using a virtual control panel, in order to optimize the analytical results and/or solve the instrument problems. When the analysis of a sample is analyzed Simulation Logic 130 can take into account any combination of a sample's virtual characteristics, user technique detected using Sample Introduction Device 115 or designated instrument conditions. Problems represented by instrument conditions may, thus, include improper flow rates, temperatures, leaks, pressures, detector response problems, electrical connections, improper chromatography columns, contamination, voltage settings, misalignment, etc.

Simulation Logic 130 then outputs the results that a sample of this composition would produce when subjected to the components inside the real scientific instrument that this sample analysis device is set to mimic. For example, a gas liquid chromatograph mimic would output a gas liquid chromatogram whereas, a mass spectrometer mimic would output a mass spectrum and a nuclear magnetic resonance instrument would display a nuclear magnetic resonance spectrum on either a display monitor or a paper chart. Much like in the authentic instrumentation these results could be saved to an electronic medium for computation and display immediately and at a future time. Simulation Logic 130A is optionally configured to simulate a specific commercial instrument while Simulation Logic 130B is configured to simulate a different commercial instrument. Thus, Simulation Logic 130A can be configured to simulate an Agilent mass spectrometer while Simulation Logic 130B can be configured to simulate a Perkin-Elmer mass spectrometer.

Since the functionality of the sample analysis device (GC, LC, MS) is controlled by the response of the sample analysis device to the user requests and the response of the sample analysis device is determined by the programmed device controlling the sample analysis device; the same sample analysis device can mimic a variety of instruments.

Display 135 can include for example a computer screen and is configured to display an output of Simulation Logic 130. For example, in the case of a Liquid Chromatograph mimic, it displays the appropriate liquid chromatogram as the result of the sample of a specific composition subjected to the user determined instrument parameters and/or user technique. In the case of a liquid chromatograph, the user determined parameters would include but not limited to: the liquid chromatographic column size, the liquid chromatographic column length, the liquid chromatographic packing composition, the solvent composition, the solvent gradient, the solvent temperature and the solvent flow.

Display 135 and/or Input 105 are optionally configured to simulate one or more commercially available data systems. In some embodiments, the user has an option to display the results immediately or in “instrument time”. In other words, a chromatogram that would take sixty minutes to complete on an authentic instrument can be played back instantly, over a period shorter than 60 minutes, or take sixty minutes to produce as if being produced on an authentic instrument. The display time is optionally set by a professor using Input 105.

One or more Data System 140 is optionally included in the computing system illustrated in FIG. 1. This data system can be a standard and/or commercially available data system, e.g., a data system from a specific manufacture such as those discussed elsewhere herein. Simulation Logic 130 and Data System 140 are optionally coupled by an API (application program interface) that appears to be an actual instrument from the view of Data System 140.

In some embodiments of this system can be fitted over a real operational gas chromatograph. The gas chromatograph can then be operated in ‘simulation’ or ‘student’ mode where no real sample is introduced onto the chromatographic column but the instrument reacts and responds in a way that mimics the introduction and analysis of a real sample. An appropriately outfitted syringe is used as the sample introduction device.

### A SPECIFIC EXAMPLE

### Device Identification

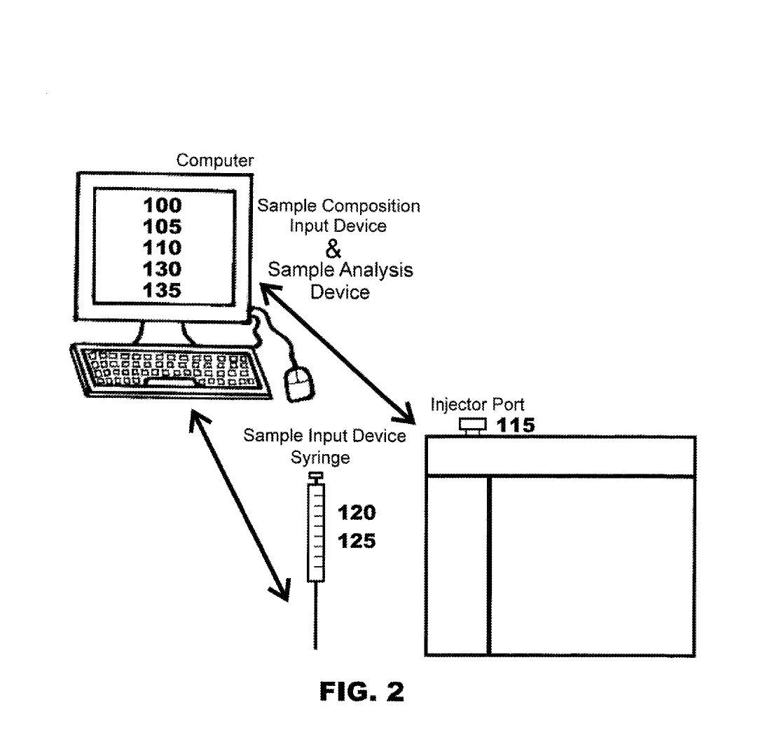

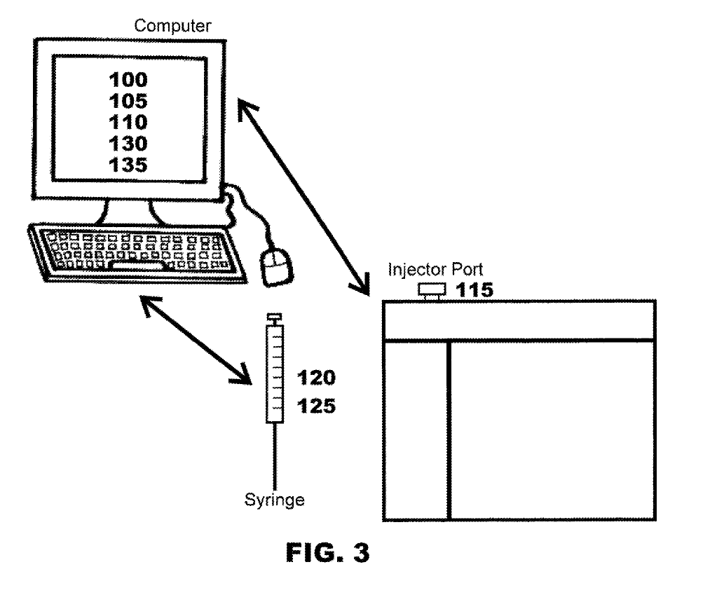

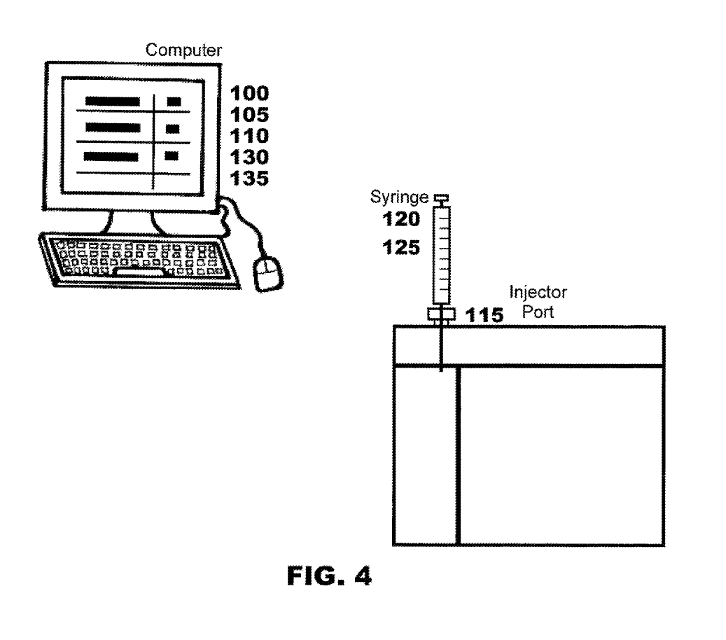

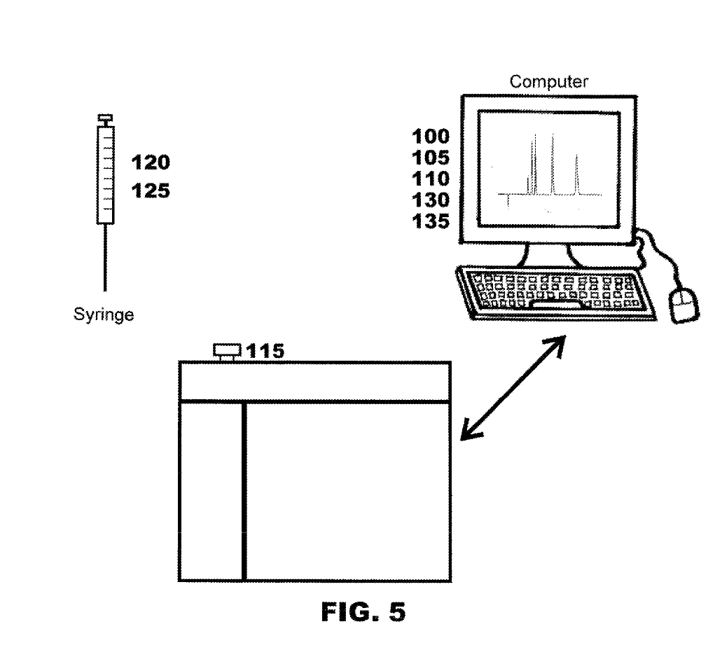

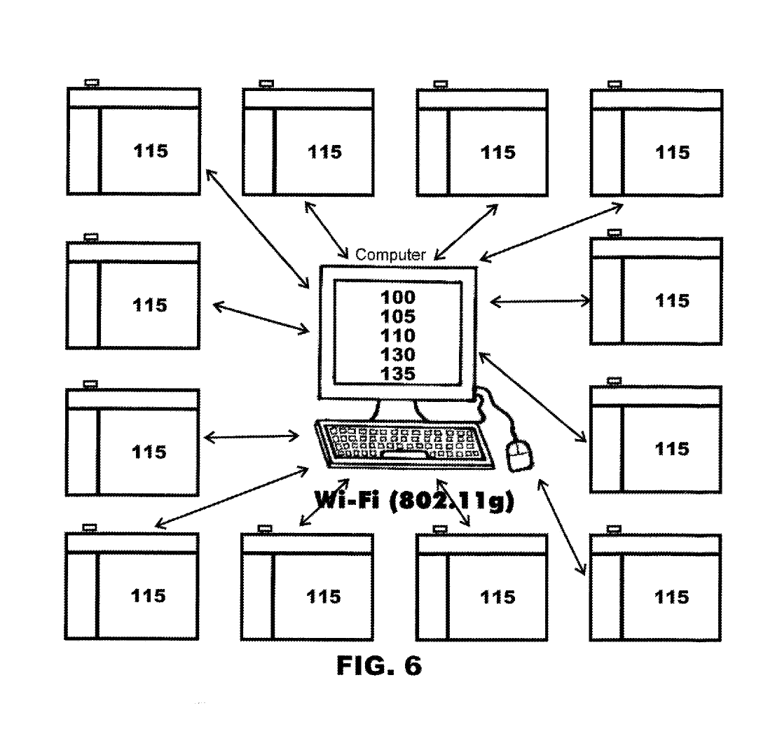

FIG. 2, FIG. 3, FIG. 4 and FIG. 5. In this case, part of the sample input device is shaped like the familiar syringe used to inject sample into the gas chromatograph.

Part of the Sample Introduction Device is a physical box shaped like a generic gas chromatograph. The injector port accommodates the syringe in the same way that the gas chromatograph injector port accommodates a syringe.

The computing system is a desktop computer.

### Communication Between Devices

Communication between devices can be wired or wireless; wired can be USB (Universal Serial Bus) while wireless can be RFID (Radio Frequency Identification), Bluetooth, NFC (Near Field Communication) or Wi-Fi (802.11g). In this example, the communication between the computer (Sample Composition Input Device) and the syringe (Sample Input Device) is RFID. The communication between the syringe (Sample Input Device) and gas chromatograph injector port (Sample Results Output Device) is Bluetooth. Communication between the gas chromatograph (Sample Results Output Device) and the computer (Sample Analysis Device) is Wi-Fi.

Step 1: Load Gas Chromatograph with Analysis Parameters

FIG. 2. Initially, the gas chromatographic analysis parameters are electronically transferred to Memory 110. The analysis parameters include items such as the identity of the gas chromatographic column, gas flow rate and oven temperature gradient.

Step 2: Load Syringe with Sample Composition

FIG. 3. To begin the process, the user enters the analyte names and amounts into a spreadsheet like interface. A unique syringe identity is automatically added. An example is listed in Table 1. Once the user indicates that the input process is complete, the computer optionally sends the information to the syringe. This can be done wirelessly. A wireless connection can be accomplished via RFID. In addition to sample composition, a unique identifier is uploaded for each syringe. Once the data upload to each syringe is completed, the syringes are then ready to ‘inject the samples’ into the gas chromatograph.

### Step 3: Load Sample Composition Onto Chromatograph

FIG. 4. The syringe is manually inserted into the injection port. Once the plunger on the syringe is engaged, the sample composition along with the characteristics of the injection is transmitted to the computing system and the chromatographic analysis begins. Much like in a laboratory setting, an automatic sampler device can be fashioned to mimic the injection of multiple samples without user intervention.

### Step 4: Gas Chromatograph Produces Chromatogram

FIG. 5. In some embodiments, the virtual analytes available for analysis are predetermined and limited to a finite number; there is no requirement for a generalized simulation algorithm. The peak elution times can be determined from a simple table of retention times. These retention times can be derived from published literature, manufacturers' column and analytical method specifications or standards analyzed by an instrument owned by the user.

Regardless of the method, taking into account the characteristics of the injection, the gas chromatographic conditions and the sample composition, the chromatogram is produced. The computer system can be set to produce the chromatogram instantly or in “instrument time”. Chromatographic time mimics the time it would take for the actual chromatogram to be produced. For example, if under ‘normal chromatographic conditions’ it would take thirty minutes for the last peaks to elute from the column, then the sample results output device (135) would take thirty minutes to produce a chromatogram. It would be to the benefit of the student to run the system in ‘chromatographic time’ so that the student could get used to the ‘tempo’ of chromatography. Alternatively, instrument time can be accelerated so that a greater number of analyses can be completed in a limited time.

### One Computer Controls Multiple Gas Chromatographs

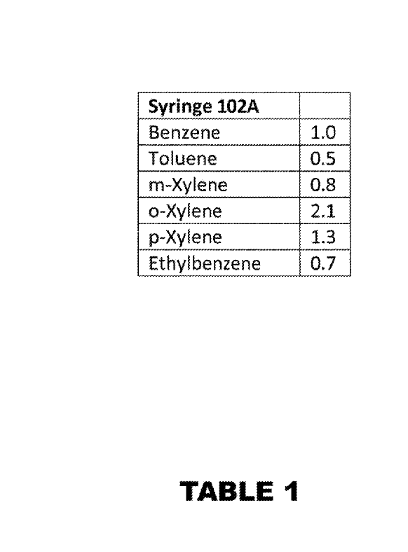

FIG. 6. Because the computation requirements of this device are minimal, it is possible to run multiple simulations on a single computer. Communications to and from each sample introduction device is optionally done via Wi-Fi (802.11 g) or Ethernet, similar to network devices where each device has its own IP (Internet Protocol) address.

Several embodiments are specifically illustrated and/or described herein. However, it will be appreciated that modifications and variations are covered by the above teachings and within the scope of the appended claims without departing from the spirit and intended scope thereof For example the systems and methods described herein may be applied to training for medical devices, computers, manufacturing systems, and/or the like. The method steps disclosed herein are optionally performed in alternative orders.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. Logic described herein includes hardware, firmware and/or software stored on a computer readable storage medium. As used herein, the term “configured to” is meant to mean that an element has some physical feature that is specifically constructed, formed or arrange so as to perform one or more specific functions

### SEQUENCE LISTING

Not Applicable

1. A scientific instrument comprising: memory configured to store characteristics of a simulated sample; a sample introduction device including at least one sensor configured to detect a technique of a user, the sample introduction device being a physical device; a transducer configured to receive an output of the at least one sensor and generate a digital value based on the received output; logic configured to receive the digital value and to simulate analysis of the sample based on the digital value and the characteristics of the simulated sample; and a microprocessor configured to execute the logic.

2. The instrument of claim 1, wherein the characteristics include chemical components of the sample, a size of the sample, and/or physical properties of the sample.

3. The instrument of claim 1, wherein the memory is configured to store the characteristics of a plurality of samples.

4. The instrument of claim 1, further comprising an input configured to receive the characteristics of the simulated sample.

5. The instrument of claim 1, wherein the sample introduction device includes a syringe, a probe, a vial, or a sample plate.

6. The instrument of claim 1, wherein the sample introduction device includes a sample port.

7. The instrument of claim 1, wherein the sample introduction device includes an auto-sampler.

8. The instrument of claim 1, wherein the technique of the user is an injection technique.

9. The instrument of claim 1, wherein the at least one sensor is configured to detect movement of a syringe plunger, movement of a sample probe, speed of a syringe plunger or sample probe, a volume of liquid, a volume of gas, a temperature of a sample, and/or a pressure.

10. The instrument of claim 1, wherein the at least one sensor includes two sensors configured to detect different aspects of the technique of the user.

11. The instrument of claim 1, wherein the transducer is configured to receive a wireless signal from the at least one sensor.

12. The instrument of claim 1, wherein the transducer is configured to receive an analog signal from the at least one sensor.

13. The instrument of claim 1, wherein the analysis of the sample includes chromatography of the sample.

14. The instrument of claim 1, wherein the analysis of the sample includes optical spectroscopy, x-ray spectroscopy, atomic microscopy, electro chemistry, mass spectrometry, atomic absorption or nuclear magnetic resonance of the sample.

15. The instrument of claim 1, wherein the analysis of the sample includes simulation of instrument conditions.

16. The instrument of claim 1, wherein the analysis of the sample includes simulation of instrument errors.

17. The instrument of claim 1, wherein the analysis of the sample includes simulation of a detector response to one or more components of the sample.
